(19) United States
(12) Patent Application Publication
(10) Pub. No.: US 2006/0232541 A1
(43) Pub. Date: Oct. 19, 2006

(54) Display device and method for driving a display device

(76) Inventors: Yasuyuki Kudo, Fujisawa (JP); Takashi Shoji, Fujisawa (JP); Norio Mamba, Kawasaki (JP); Toshimitsu Matsudo, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/400,196

(22) Filed: Apr. 10, 2006

(30) Foreign Application Priority Data
Apr. 19, 2005 (JP) 2005-120848

(51) Int. Cl. G09G 3/36

(52) U.S. Cl. 345/98; 345/204

(57) ABSTRACT

A demultiplexer circuit selects one of data signals, which are sent via an output port of a data driver circuit, on a time division basis, and distributes the data signals to data lines. For high-resolution display, the demultiplexer sequentially distributes data signals to associated data lines. For low-resolution display, the demultiplexer distributes identical data signals to data lines or parts of the data lines. Gate driver circuits each sequentially drive scan lines for high-resolution display, and concurrently or temporarily concurrently drive the scan lines for low-resolution display.

### CLAIM OF PRIORITY

The present application claims priority from Japanese application serial no. 2005-120848 filed on Apr. 19, 2005, the content of which is hereby incorporated by reference into this application.

### BACKGROUND OF THE INVENTION

1. Field of the Invention

The present invention relates to an image display device such as a liquid crystal display, or more particularly, to an active matrix type display device that supports multiscanning and a method for driving the display device.

2. Description of the Related Art

Active matrix type display devices including a thin-film transistor (TFT) liquid crystal display device have been adopted as a display device to be included in a portable cellular phone or a personal digital assistant owing to such features as a thin lightweight style and low power consumption. In particular, as far as the portable cellular phone is concerned, the improvement in a resolution to be offered by the display device is promoted more earnestly than the sophistication in the performance of a camera feature or an arithmetic processing unit. However, as for the design of display screen images that express applications such as Internet contents and games provided by the portable cellular phone, a design offering a resolution of 240 horizontal pixels by three colors of red, green, and blue by 320 vertical pixels (which shall be referred to as a QVGA resolution that is a resolution stipulated in the quad video graphic array (QVGA) graphic standard) has become mainstream. Even if the display device is designed to offer a higher resolution, the resolution to be exhibited by contents will not presumably shift to the higher one immediately.

Japanese Patent Application Publication No. 2004-252102 describes a method of transforming a QVGA content into video, which is compatible with a high resolution offered by a display device, by performing enlargement so that the QVGA content can be displayed on the display device. In order to implement the method, however, a system should include an enlarging means such as an enlargement circuit or an image memory in which the same number of pixels as those displayed in a display area can be stored. This leads to an increase in a load incurred by an arithmetic processing unit or a rise in a cost.

### SUMMARY OF THE INVENTION

In order to display an image, which exhibits the currently mainstream QVGA resolution, on a display device offering a higher resolution, an enlarging means is needed. This triggers a concern about a rise in a cost.

The present invention provides a display device that displays an image and a method for driving the display device by a little modifying a conventional display device, which offers a high resolution, without the necessity of a memory whose storage capacity is large enough to hold pixels constituting a screen image displayed on the display device.

The display device in accordance with the present invention has a high-resolution display area, and includes a scan line drive unit (gate driver circuit), a data line drive unit (data driver circuit), and a data distribution unit (demultiplexer circuit) that connects the data driver circuit to data lines in a display panel (display area) and selects any of the data lines on a time division basis.

Existing data driver circuits include a data driver circuit with built-in demultiplexer circuits, for example, a QVGA data driver circuit. The QVGA data driver circuit uses demultiplexer circuits, each of which transmits three outputs via each of 240 output ports thereof, to write 240 pixels (240 by three colors of red, green, and blue).

The number of outputs to be transmitted via each output port of the demultiplexer circuit is doubled to be six, whereby the number of pixels to be written horizontally is doubled to be 480 (480 by three colors of red, green, and blue). For a high resolution, the output ports of the demultiplexer circuit are validated one by one. For a low resolution, the output ports of the demultiplexer circuit are validated in twos (in parallel). Thus, display data is horizontally doubled or horizontally enlarged to be twice larger.

As mentioned above, the number of outputs to be transmitted via each output port of the demultiplexer circuit is designated based on a resolution to be supported by multiscanning. For high-resolution display, one output is written on each data line. For low-resolution display, a plurality of data lines is written concurrently (in parallel) in order to implement the multiscanning. Since the timing of controlling the demultiplexer circuit and the timing of controlling the gate driver circuit vary depending on whichever of the high-resolution display and low-resolution display is performed, a timing signal generator is included in association with each of high and low resolutions.

For example, assume that multiscanning supports both of the QVGA resolution and a resolution of 480 horizontal pixels by three colors of red, green, and blue by 640 vertical pixels (which shall be referred to as a VGA resolution that is a resolution stipulated in the VGA graphic standard). For the VGA resolution, the timing of controlling the demultiplexer circuit is determined so that one line period determined in order to attain the VGA resolution will be divided into six sub-periods and data will be sequentially routed to six data lines via one output port. For the QVGA resolution, the timing of controlling the demultiplexer circuit is determined so that two line periods each determined in order to attain the. VGA resolution will be divided into three sub-periods and two data lines will be selected at one time in order to horizontally enlarge display-data.

Likewise, for the VGA resolution, the timing of controlling the gate driver circuit is determined so that one line will be scanned during one line period. For the QVGA resolution, the timing of controlling the gate driver circuit is determined so that two lines will be concurrently (in parallel) scanned during two line periods, each of which is determined in order to attain the VGA resolution, in order to vertically enlarge display data.

According to the present invention, a high-resolution display device having an existing data driver circuit partly modified and including demultiplexer circuits can support multiscanning, offer a high resolution, and display existing contents. The present invention can be constructed by merely partly modifying an existing data driver circuit. Consequently, the multiscanning feature can be implemented in the display device with the same cost as the one currently required for peripheral circuits and the same man-hours required for designing as currently required ones.

Moreover, the present invention can be effectively adapted, especially, to a display device to be included in a portable cellular phone or a personal digital assistant.

### BRIEF DESCRIPTION OF THE DRAWINGS

FIG. 1 shows the internal configuration of a liquid crystal panel employed in a first embodiment of the present invention;

FIGS. 2A, 2B, and 2C show timing charts concerning VGA display achieved by the first embodiment of the present invention;

FIGS. 3A, 3B, and 3C show timing charts concerning QVGA display achieved by the first embodiment of the present invention;

FIG. 4 shows the configuration of an LSI with a built-in memory employed in the first embodiment of the present invention;

FIG. 5 shows the configuration of an LSI employed in the first embodiment of the present invention;

FIG. 6 shows the configuration of a second embodiment of the present invention;

FIGS. 7A, 7B, and 7C show timing charts concerning VGA display achieved by the second embodiment of the present invention;

FIGS. 8A and 8B show timing charts concerning QVGA display achieved by the second embodiment of the present invention;

FIG. 9 shows the configuration of a third embodiment of the present invention;

FIGS. 10A and 10B show timing charts concerning the third embodiment of the present invention; and

FIGS. 11A and 11B show examples of display achieved by the third embodiment of the present invention.

### DESCRIPTION OF THE PREFERRED EMBODIMENTS OF THE INVENTION

### First Embodiment

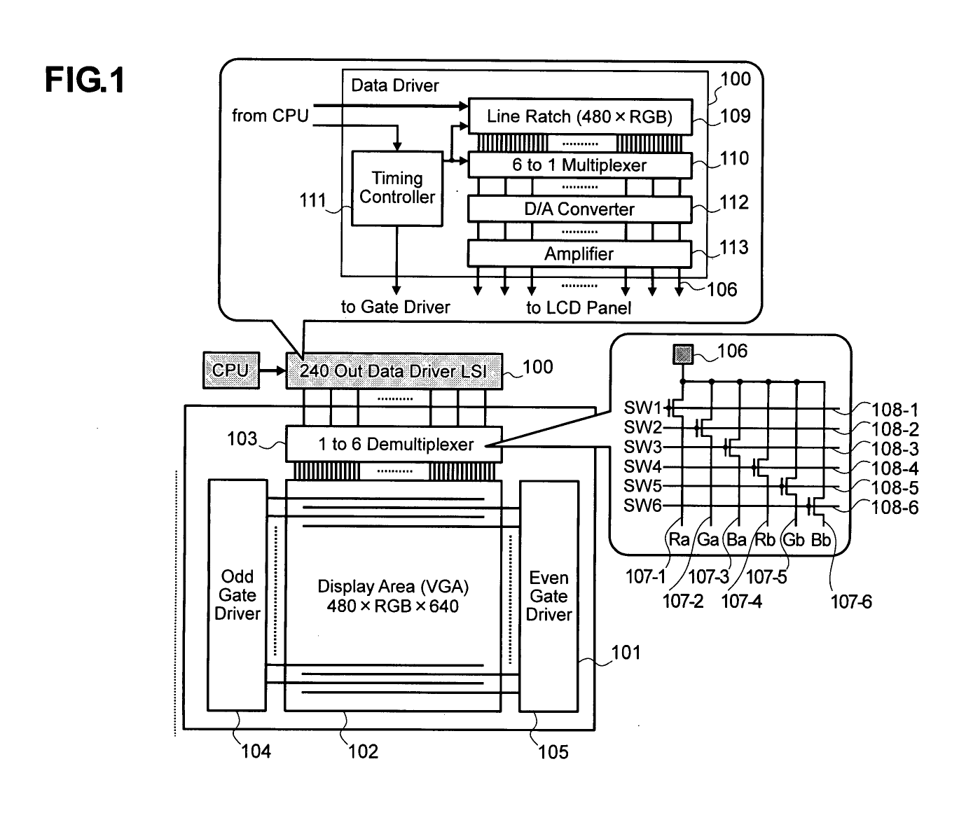

Referring to FIG. 1 to FIG. 5, a description will be made of an active matrix type display device and a driving method in accordance with the present invention. A liquid crystal display device will be taken as an example of the active matrix type display device. The present invention can also be adapted to an active matrix type display device employing organic electroluminescence (EL) or the like.

FIG. 1 shows the configuration of a liquid crystal display device in accordance with the present embodiment. The liquid crystal display device includes a data driver circuit 100 and a liquid crystal panel 101. The liquid crystal panel 101 includes a VGA-conformable display area 102, demultiplexer circuits 103 each including one input port and six output ports, an odd-line gate driver circuit 104 including three hundred and twenty output ports, and an even-line gate driver circuit 105 including three hundred and twenty output ports.

Each of the demultiplexer circuits 103 is connected to one output port 106 of the data driver circuit 100 and onto six data lines 107-1 to 107-6 in the display area (a first-pixel red data line Ra, a first-pixel green data line Ga, a first-pixel blue data line Ba, a second-pixel red data line Rb, a second-pixel green data line Gb, and a second-pixel blue data line Bb). Based on six control signals SW1 to SW6 (applied to control lines 108-1 to 108-6 respectively) associated with the respective data lines 107-1 to 107-6, the demultiplexer circuit 103 distributes display gray-level voltages sent via the one output port 106 to the data lines 107-1 to 107-6 on a time division basis.

Herein, two hundred and forty one-input six-output demultiplexer circuits 103 are included in association with two hundred and forty output ports of the data driver circuit 100. The control signals SW1 to SW6 (applied to the control lines 108-1 to 108-6 respectively) may be used in common among the two hundred and forty demultiplexer circuits 103.

The data driver circuit 100 is realized with a conventional data driver LSI that conforms to the QVGA standard and includes two hundred and forty output ports. A line latch circuit 109, a multiplexer circuit 110, and a timing signal generator circuit 111 are realized by a bit modifying conventional ones. The line latch circuit 109 latches data that is equivalent to a product of 480 pixels by three colors of red, green, and blue and that constitutes one line. The multiplexer circuit 110 has six input ports and one output port.

Accordingly, the timing signal generator circuit 111 is modified so that a control signal to be fed to the six-input one-output multiplexer circuit 111 and a control signal to be fed to the one-input six-output demultiplexer circuits 103 will be changed from ones to others according to an external control signal with which resolutions supported by multiscanning are switched. A digital-to-analog converter circuit 112 and a signal amplifier circuit 113 may have the same circuitry as conventional ones.

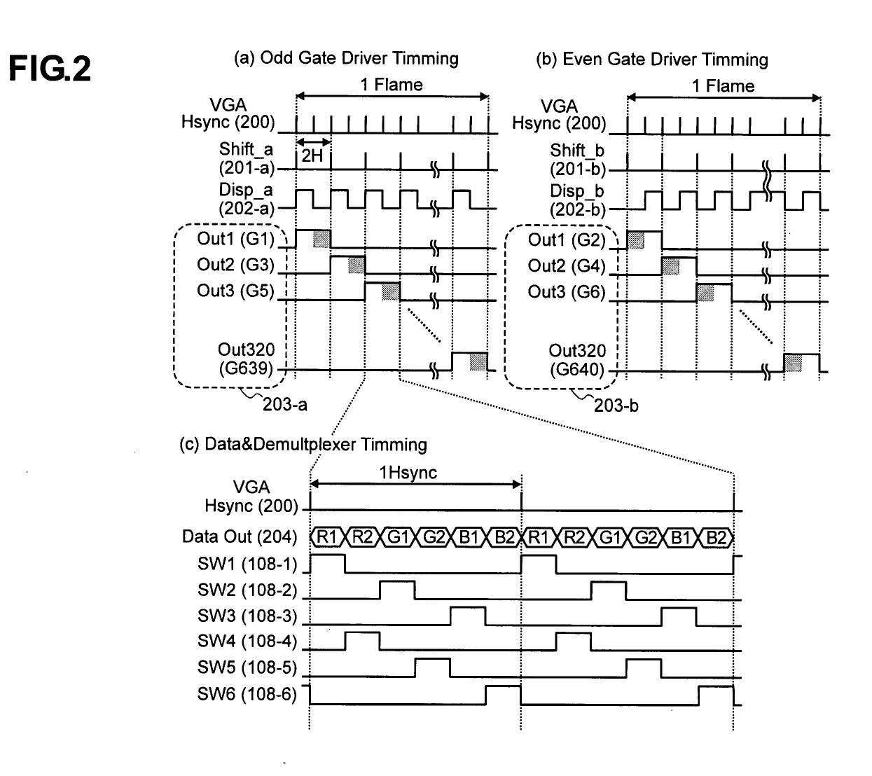

FIGS. 2A, 2B, and 2C show timing charts concerning a case where VGA display data exhibiting as high a resolution as the resolution offered by the display area is received.

FIG. 2A is a timing chart relevant to the odd-line gate driver circuit 104. When a horizontal period signal VGAHsync (200) for VGA display is used as a reference signal, a timing signal Shift_a (201-a) with which the output ports of the gate driver circuit 104 are shifted rises at intervals of two horizontal periods ((2H) where 1H denotes one horizontal period). A mask signal Disp_a (202-1) is transferred to the gate driver circuit 104 as a signal that is reversed at the timing of validating an odd line to which a VGA display data signal is applied, that is, at intervals of 1H. Consequently, gate outputs 203-a (Out1, Out2, etc., and Out 320) are transmitted as signals that sweep along odd lines while being shifted at intervals of 2H.

FIG. 2B is a timing chart relevant to the even-line gate driver circuit 105. Similarly to the case of the odd-line gate driver circuit 104, when a signal VGAHsync (200) is used as a reference signal, a timing signal Shift_b (201-b) with which the output ports of the gate driver circuit 105 are shifted rises at intervals of 2H. Since the gate driver circuit 105 is designed to handle odd lines, a mask signal Disp_b (201-b) is transferred to the gate driver circuit 105 as a signal that is reversed at the timing of validating an even line, that is, produced as the reverse of the odd-line mask signal Disp_a (202-1) which is reversed at intervals of 1H. Consequently, gate outputs 203-b (Out1, Out2, etc., and Out320) are transmitted as signals that sweep along even lines while being shifted at intervals of 2H.

FIG. 2C is a timing chart relevant to the data driver circuit 100 and one-input six-output demultiplexer circuits 103. The data driver circuit 100 includes the line latch circuit 109 that latches display data representing one VGA line that is one line in VGA-resolution display. Using a horizontal period signal VGAHsync (200) employed in VGA display as a reference signal, the data driver circuit 100 sequentially transfers six display gray-level voltages DataOut (204) (a first-pixel red gray-level voltage R1, a first-pixel green gray-level voltage G1, a first-pixel blue gray-level voltage B1, a second-pixel red gray-level voltage R2, a second-pixel green gray-level voltage G2, and a second-pixel blue gray-level voltage B2), which represent two pixels and of which cycles correspond to one sixth of 1H, to one of the demultiplexer circuits 103 via one output port 106 thereof.

Since the number of output ports included in the data driver circuit 100 is 240, the data driver circuit 100 transmits one thousand, four hundred and forty (=240×6(480×three colors of red, green, and blue)) during 1H. The control signals SW1 to SW6 (applied to the control lines 108-1 to 108-6 respectively) are set to an on state one by one in order dependent on the order, in which the display gray-level voltages DataOut (204) are transferred, so that each control signal will assume the on state during one sixth of the 1H period.

For example, when the display gray-level voltages DataOut (204) are transferred in order of voltages R1, R2, G1, G2, B1, and B2, the control signals SWn (where n denotes any value ranging from 1 to 6) to be associated with the voltages are validated in order of signals SW1, SW4, SW2, SW5, SW3, and SW6 so that the gray-level voltages will be one by one applied to the respective data lines 107-1 to 107-6.

Consequently, the display gray-level voltages can be applied to the data lines, which handle two horizontal pixels, via one output port of the data driver circuit 100 during the 1H period. Since the number of output ports of the data driver circuit 100 is 240, data of 480 pixels can be transferred.

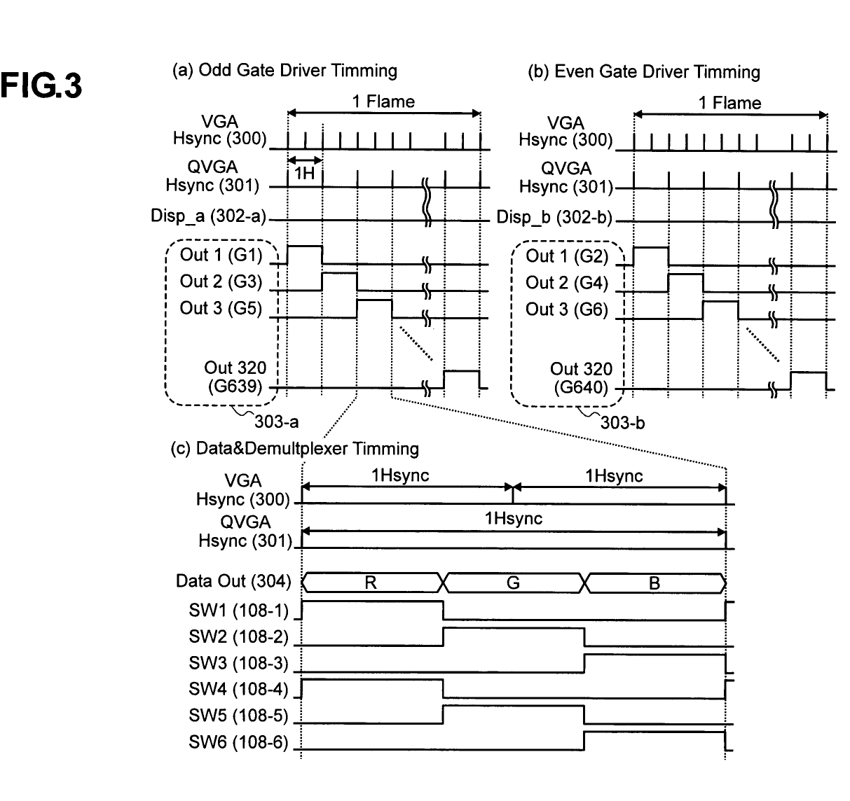

FIGS. 3A, 3B, and 3C show timing charts concerning a case where QVGA display data exhibiting a low resolution that is a mainstream resolution exhibited by contents provided by portable cellular phones is received.

FIG. 3A is a timing chart relevant to the odd-line gate driver circuit 104. When a horizontal period signal VGAHsync (300) for VGA display in the display area is used as a reference signal, a signal that rises at intervals of 2H is adopted as a timing signal with which the output ports of the gate driver circuit 104 are shifted. When a horizontal period signal QVGAHsync (301) for QVGA display is used as a reference signal, a signal that rises at intervals of 1H is adopted as the timing signal. A mask signal Disp_a (302-a) that signifies unmasking is transferred to the gate driver circuit 104.

Assuming that a frame memory capable of holding QVGA display data expressing one screen image is included, the horizontal sync signal to be used as a reference signal (VGAHsync (300) or QVGAHsync (301)) is produced synchronously with an output display gray level at the timing independent of an input. However, if the frame memory is not included, since the output display gray level is supplied at the timing synchronous with an input, the horizontal sync signal should be produced synchronously with the input. Consequently, the gate outputs 303-a (Out1, Out2, etc., and Out320) are transmitted as signals with which gates are sequentially opened and which are shifted at intervals of 1H indicated with the QVGA reference signal or at intervals of 2H indicated by the VGA reference signal.

FIG. 3B is a timing chart relevant to the even-line gate driver circuit 105. According to the timing chart, the even-line gate driver circuit 105 acts similarly to the odd-line gate driver circuit 104. When the horizontal period signal VGAHsync (300) for VGA display is used as a reference signal, a signal that rises at intervals of 2H is adopted as a timing signal with which the output ports of the gate driver circuit 105 are shifted. When the horizontal period signal QVGAHsync (301) for QVGA display represented by an input signal is used as a reference signal, a signal that rises at intervals of 1H is adopted as the timing signal. A mask signal Disp_b (302-b) that signifies unmasking is transferred to the gate driver circuit 105. Consequently, the gate outputs 303-b (Out1, Out2, etc., and Out320) are transmitted as signals with which gates are sequentially opened and which are shifted at intervals of 1H indicated by the QVGA reference signal or 2H indicated by the VGA reference signal.

FIG. 3C is a timing chart relevant to the data driver circuit 100 and one-input six-output demultiplexer circuits 103. The data driver circuit 100 uses the 2H period indicated by the horizontal period signal VGAHsync (300) for VGA display or the 1H period indicated by the horizontal period signal QVGAHsync (301) for QVGA display as a reference signal, and transfers three display gray-level voltages DataOut (304) (red data R, green data G, and blue data B), of which cycles correspond to one third of the 1H period indicated by the QVGA horizontal period signal (equivalent to the 2H period indicated by the VGA horizontal period signal), sequentially to one of the one-input six-output demultiplexer circuits 103 via one output port 106 thereof.

Since the number of one-input six-output demultiplexer circuits 103 is 240, seven hundred and twenty (=240×3 (240×three colors of red, green, and blue)) display data items are transmitted during the 1H period for QVGA display (equivalent to the 2H period for VGA display). The control signals SW1 to SW6 (108-1 to 108-6) are set to an on state in twos in order dependent on the order in which the display gray-level voltages DataOut (304) are transferred. At this time, the 1H period for QVGA display (equivalent to the 2H period for VGA display) is trisected so that each control signal will assume the on state during one third of 1H.

For example, assume that the display gray-level voltages DataOut (304) are transferred in order of voltages R, G, and B, the control signals SWn (where n denotes a value ranging from 1 to 6) to be associated with the voltages are validated in order of paired signals SW1 and SW4, SW2 and SW5, and SW3 and SW6. The gray-level voltages are sequentially applied to pairs of adjoining ones of the respectively data lines 107-1 to 107-6. Consequently, identical display data is written at the locations of two horizontal pixels and two vertical pixels in the display area for VGA display. Thus, enlarged QVGA display is achieved.

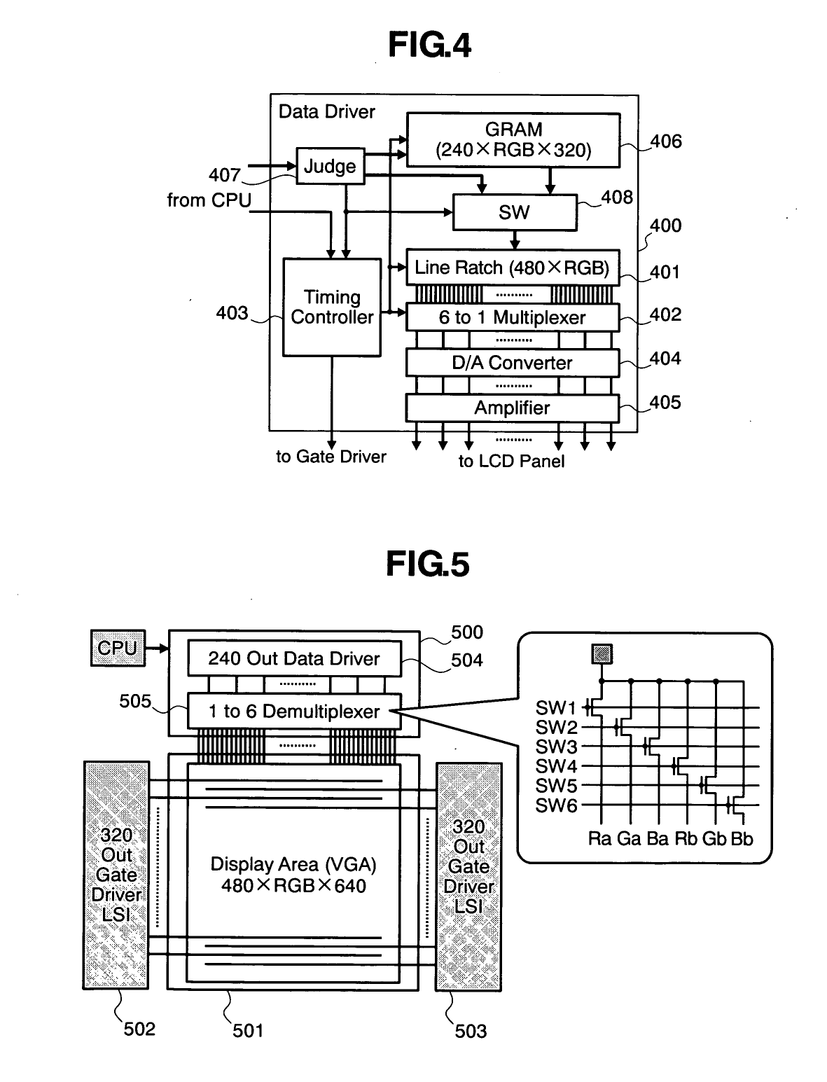

FIG. 4 shows the configuration of a data driver circuit 400 that is a version of the data driver circuit 100, which is employed in the present embodiment, including a frame memory capable of preserving data of one screen image for QVGA display.

In FIG. 4, the data driver circuit 400 includes, similarly to the data driver circuit 100 shown in FIG. 1, a line latch circuit 401, a six-input one-output multiplexer circuit 402, a timing signal generator circuit 430, a digital-to-analog converter circuit 404, and a signal amplifier circuit 405. The data driver circuit 400 further includes a frame memory 406 capable of preserving data of one screen image for QVGA display, an input data checking circuit 407, and a data switching circuit 408.

The input data checking circuit 407 checks a resolution exhibited by externally received display data, checks if reception of display data should be interrupted, stores display data in the frame memory 206, or transfers display data to the line latch circuit 401.

If the input data checking circuit 407 recognizes externally received display data as data conformable to the QVGA graphic standard, the foregoing enlargement is performed for display. If the input data checking circuit 407 recognizes the externally received display data as data conformable to the VGA graphic standard, the VGA input display data is not stored in the frame memory 406 but is displayed according to the aforesaid method via the data switching circuit 408.

Reception of external display data may be interrupted, and QVGA display data stored in the frame memory may be enlarged according to the aforesaid method and displayed. In this case, supply of external display data is not needed, that is, an external unit (CPU) can be halted. Eventually, display can be achieved with the power consumption of an entire system held low.

Furthermore, when VGA display data is received, every fourth pixel may be stored. A quarter of the VGA data that is stored may be enlarged according to the aforesaid method and then displayed. In this case, display can be achieved with low power consumption without the necessity of external display data.

As mentioned above, a typical QVGA data driver LSI, and a gate driver circuit, demultiplexer circuits, and other simple circuits included in a liquid crystal panel make it possible to implement multiscanning that is compatible with both the VGA and QVGA graphic standards. The multiscanning modes associated with the VGA and QVGA graphic standards can be dynamically switched. Specifically, the display device checks a manipulation performed at a system (external equipment) or checks transferred input data so as to determine either of the multiscanning modes.

Moreover, although the present embodiment has been described by taking for instance multiscanning that is compatible with both the VGA and QVGA graphic standards, the present invention can be applied to multiscanning that is compatible with other graphic standards including the common intermediate format (CIF) (352×RGB×288), quarter common intermediate format (QCIF) (176×RGB×144), UXGA (1600×RGB×1200), and super video graphics array (SVGA) (800×RGB×600). Herein, a ratio of a horizontal resolution to a vertical resolution is 2:1. In this case, CIF, QCIF, etc. should be read for VGA and QVGA in the above description. The same constituent features as the aforesaid ones can be applied to these graphic standards but the present invention is not limited to the VGA and QVGA graphic standards.

In FIG. 1, the demultiplexer circuits 103, odd-line gate driver circuit 104, and even-line gate driver circuit 105 are incorporated in the display panel 101. In FIG. 5, a display device includes a data driver LSI 500, a liquid crystal panel 501 whose display area offers the VGA resolution, an odd-line gate driver LSI 502 having three hundred and twenty output ports, and an even-line gate driver LSI 503 having three hundred and twenty output ports.

The data driver LSI 500 includes a data driver circuit 504 and one-input six-output demultiplexer circuits 505. The gate driver LSIs 502 and 503 are realized with general products, for example, gate driver LSIs that support the QVGA graphic standard and have three hundred and twenty output ports.

The present embodiment includes two gate driver circuits. One gate driver or numerous gate drivers may be employed in order to achieve the same actions. The number of gate drivers to be included may be determined arbitrarily.

As mentioned above, the present invention can be implemented by modifying the demultiplexer circuits included in an existing data driver and devising the connections of gate lines in a liquid crystal panel. Even the LSI structure shown in FIG. 5 permits the same actions as those performed in the display device shown in FIG. 1.

### Second Embodiment

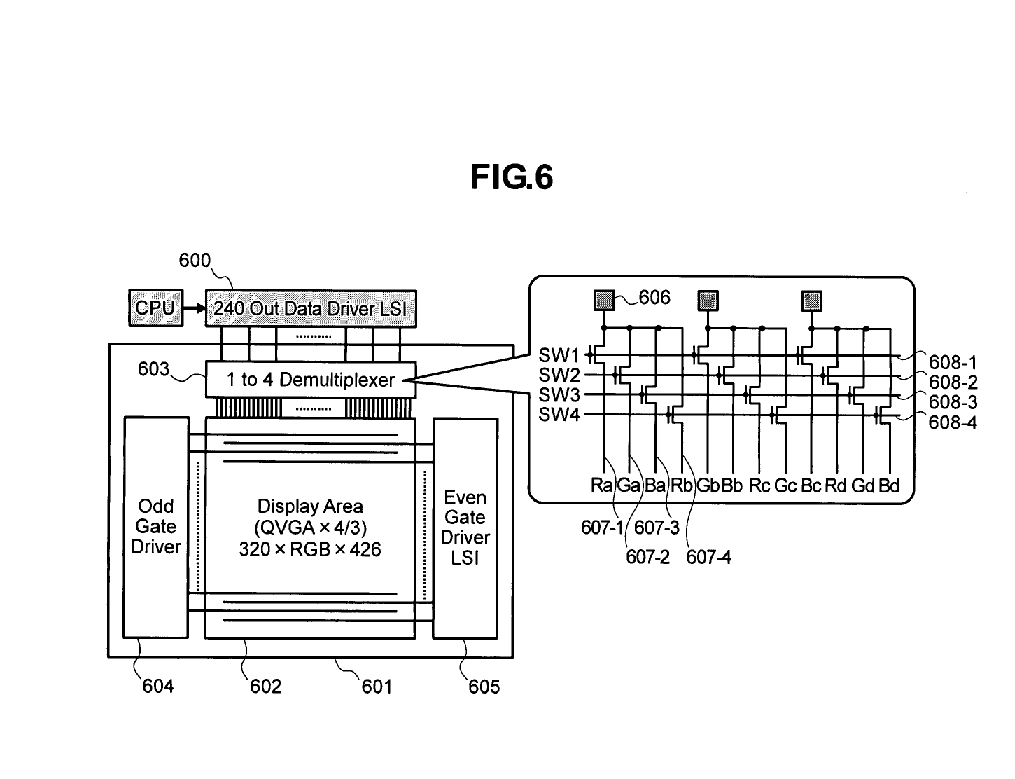

An active matrix type display device and a driving method in accordance with the present invention will be described in conjunction with FIG. 6 to FIGS. 8A to 8C.

FIG. 6 shows the configuration of a liquid crystal display device in accordance with the present invention. The liquid crystal display device includes a data driver circuit 600 and a liquid crystal panel 601. The data driver circuit 600 is identical to a conventional data driver LSI having two hundred and forty output ports and supporting the QVGA graphic standard except that a line latch circuit and a timing signal generator included therein are slightly modified. The liquid crystal panel 601 includes a display area 602 which offers a resolution of 320 horizontal pixels by three colors of red, green, and blue by 426 vertical pixels (hereinafter, a QVGA×4/3 resolution) and in which the long side of QVGA data can be displayed horizontally, one-input four-output demultiplexer circuits 603, an odd-line gate driver circuit 604 having two hundred and thirteen output ports, and an even-line gate driver circuit 605 having two hundred and thirteen output ports.

Each of the one-input four-output demultiplexer circuits 603 is connected to one output port 606 of the data driver circuit 600, and connected onto four data lines 607-1 to 607-4 included in the display area 602 (in a first pattern that shall be called an R pattern, the data lines serve as a first-pixel red data line Ra, a first-pixel green data line Ga, a first-pixel blue data line Ba, and a second-pixel red data line Rb; in a second pattern that shall be called a G pattern, the data lines serve as a second-pixel green data line Bg, a second-pixel blue data line Bb, a third-pixel red data line Rc, and a third-pixel green data line; and in a third pattern that shall be called a B pattern, the data lines serve as a third-pixel blue data line Bc, a fourth-pixel red data line Rd, a fourth-pixel green data line Gd, and a fourth-pixel blue data line Bd) (the three patterns are repeatedly alternated relative to every set of three output ports). In response to four control signals SW1 to SW4 associated with the respective data lines 607-1 to 607-4 (applied to the respective control lines 608-1 to 608-4), the gray-level voltages transmitted via the output port 606 are distributed to the data lines 607-1 to 07-4 on a time division basis.

In association with the two hundred and forty output ports of the data driver circuit 600, two hundred and forty one-input four-output demultiplexer circuits 603 are included. The control signals SW1 to SW4 (applied to the respective control lines 608-1 to 608-4) may be used in common among the two hundred and forty demultiplexer circuits 603.

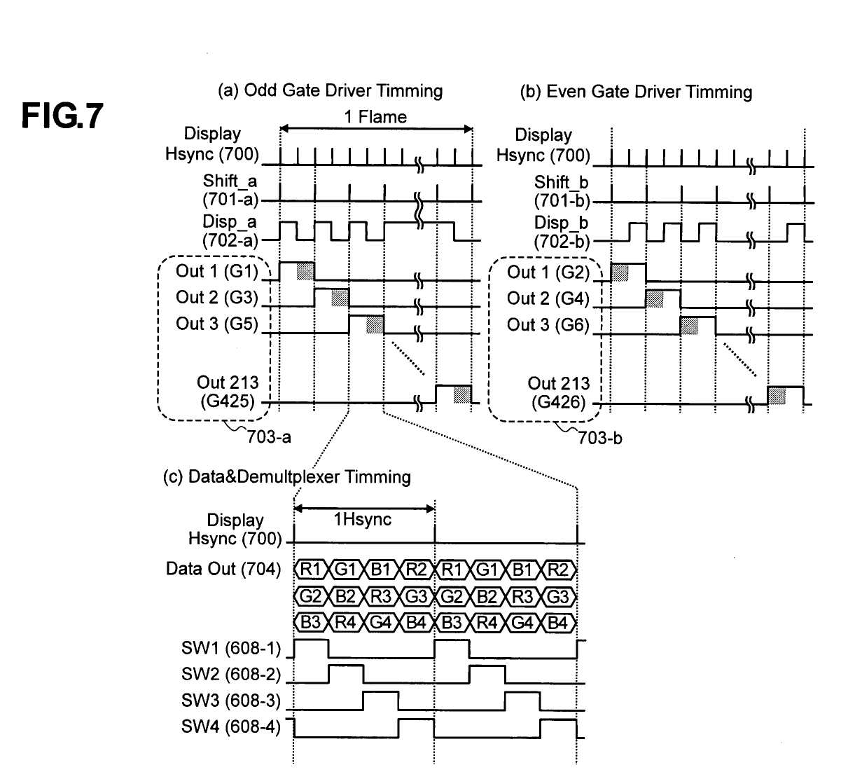

FIGS. 7A, 7B, and 7C show timing charts concerning a case where QVGA×4/3display data exhibiting as high a resolution as the resolution offered by the display area is received.

FIG. 7A is a timing chart relevant to the odd-line gate driver circuit 604. Herein, a horizontal period signal DisplayHsync (700) for QVGA×4/3 display is used as a reference signal. A timing signal Shift_a (701-a) with which the output ports of the gate driver circuit 604 are shifted rises at intervals of 2H. A mask signal Disp_a (702-a) is transferred to the gate driver circuit 604 as a signal that is reversed at the timing of validating an odd line to which the QVGA×4/3 display data signal is applied, that is, reversed at intervals of 1H. Consequently, gate outputs 703-a (Out1, Out2, etc., and Out213) are transmitted as signals that sweep along odd lines while being shifted at intervals of 2H.

FIG. 7B is a timing chart relevant to the even-line gate driver circuit 605. Similarly to the odd-line gate driver circuit 604, the even-line gate driver circuit 605 uses the signal DisplayHsync (700) as a reference signal. A timing signal Shift_b (701-b) with which the output ports of the gate driver circuit 605 are shifted rises at intervals of 2H. Since the gate driver circuit 605 handles even lines, a mask signal Disp_b (702-b) is transferred to the gate driver circuit 605 as a signal that is reversed at the timing of validating an even line, that is, as a signal that is the reverse of the odd-line mask signal Disp_a (702-a) which is reversed at intervals of 1H. Consequently, gate outputs 703-b (Out1, Out2, etc., and Out213) are transmitted as signals that sweep along even lines while being shifted at intervals of 2H.

FIG. 7C is a timing chart relevant to the data driver circuit 600 and one-input four-output demultiplexer circuits 603. The data driver circuit 600 includes a circuit that latches display data which exhibits the QVGA×4/3 resolution and represents one line. Herein, a horizontal period signal DisplayHsync (700) for QVGA×4/3 display is used as a reference signal. Four display gray-level voltages DataOut (704) whose cycles are equivalent to a quarter of 1H (for the R pattern, they are a first-pixel red gray-level voltage R1, a first-pixel green gray-level voltage G1, a first-pixel blue gray-level voltage B1, and a second-pixel red gray-level voltage R2; for the G pattern, they are a second-pixel green gray-level voltage G2, a second-pixel blue gray-level voltage B2, a third-pixel red gray-level voltage R3, and a third-pixel green gray-level voltage G3; and for the B pattern, they are a third-pixel blue gray-level voltage B3, a fourth-pixel red gray-level voltage R4, a fourth-pixel green gray-level voltage G4, and a fourth-pixel blue gray-level voltage B4) are transferred sequentially to one of the one-input four-output demultiplexer circuits 603 via one output port of the data driver circuit 600.

Since the number of one-input four-output demultiplexer circuits 603 is 240, nine hundred and sixty (=240×4 (320×three colors of red, green, and blue)) display data items are transmitted during the 1H period. The control signals SW1 to SW4 (applied to the control lines 608-1 to 608-4 respectively) are set to an on state one by one in order dependent on the order in which the display gray-level voltages DataOut (704) are transferred. At this time, the 1H period is quadrisected so that each control signal will assume the on state during a quarter of the 1H period.

For example, for the R pattern, the display gray-level voltages DataOut (704) are transferred in order of voltages R1, G1, B1, and R2. The control signals SWn (where n denotes a value ranging from 1 to 4) associated with the voltages are validated in order of signals SW1, SW2, SW3, and SW4. Consequently, the gray-level voltages are applied to the respective data lines 607-1 to 607-4 one by one.

As mentioned above, display gray-level voltages are applied to data lines, to which four horizontal sub-pixels (one pixel shall be composed of three sub-pixels) are routed, via one output port of the data driver circuit 600 during the 1H period. Consequently, the 240-output data driver can transfer data items of 960 sub-pixels, that is, 320 pixels.

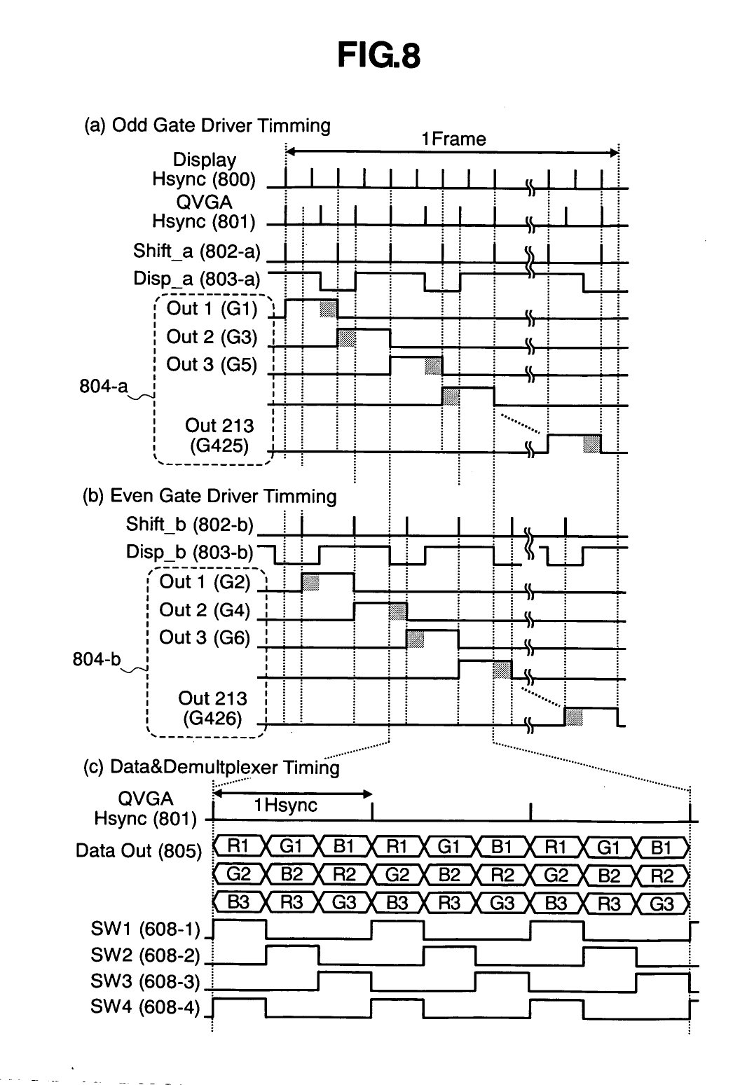

FIGS. 8A, 8B, and 8C show timing charts concerning a case where QVGA display data exhibiting a low resolution that is a mainstream resolution exhibited by contents to be provided by portable cellular phones.

FIG. 8A is a timing chart relevant to the odd-line gate driver circuit 604. Herein, a horizontal period signal DisplayHsync (800) for QVGA×4/3 display in the display area and a horizontal period signal QVGAHsync (801) for display of input QVGA data are used as reference signals.

The relationship between the two horizontal sync signals DisplayHsync (800) and QVGAHsync (801) that act as reference signals is established so that the signal DisplayHsync (800) will exhibit a 4H cycle while the signal QVGAHsync (801) will exhibit a 3H cycle, that is, the beginning of the first line at which the signal DisplayHsync (800) rises will be synchronized with the beginning of the first line at which the signal QVGAHsync (801) rises.

Moreover, when the frame memory capable of preserving QVGA display data that represents one screen image is included, the reference signals are produced synchronously with an output display gray-level signal independently of an input signal. However, when the frame memory is not included, since the output display gray-level signal is transmitted at the timing synchronous with the input signal, the signal DisplayHsync (800) must be produced synchronously with the input signal.

Consequently, a timing signal Shift_a (802-a) with which the output ports of the gate driver circuit 604 are shifted is synchronous with the beginning of the first line at which the signal QVGAHsync (801) rises, and synchronous with a rise of the signal DisplayHsync (800) occurring at intervals of 2H. In other words, the signal QVGAHsync (801) is a signal that rises at intervals of 1.5H indicated by the signal DisplayHsync (800).

Moreover, a mask signal Disp_a (803-a) is transferred to the gate driver circuit 604. At this time, the mask signal assumes an on state during the first 1H period within the 3H cycle of the signal QVGAHsync (801) used as a reference signal, an off state during the second 1H period, and the on state during the third 1H period. Consequently, gate outputs 804-a (Out1, Out2, etc., and Out213) are transmitted as signals with which gates are opened at the timings of the first and third 1H periods within the 3H cycle of the QVGA reference signal.

FIG. 8B is a timing chart relevant to the even-line gate driver circuit 605. Similarly to the odd-line gate driver circuit 604, the even-line gate driver circuit 605 uses the signals DisplayHsync (800) and QVGAHsync (801) as reference signals. A timing signal Shift_b (802-b) with which the output ports of the gate driver circuit 605 are shifted is a signal that rises at intervals of 2H indicated by the signal DisplayHsync (800) that lags behind the signal QVGAHsync (801) by a time equivalent to 0.5 line. Moreover, a mask signal Disp_b (803-b) is transferred to the gate driver circuit 605. At this time, the mask signal assumes an off state during the first 1H period within the 3H cycle of the signal QVGAHsync (801) used as a reference signal, an on state during the second 1H period, and the on state during the third 1H period. Consequently, gate outputs 804-b (Out1, Out2, etc., and Out213) are transmitted as signals with which gates are opened at the timings of the second and third 1H periods within the 3H cycle of the QVGA reference signal.

According to the driving method indicated in FIG. 8A and FIG. 8B, the even outputs (Out2, Out4, etc.) of the odd-line gate driver circuit 604 and even-line gate driver circuit 605 have the same timings. In other words, in QVGA×4/3 display, the same display data is written on the third and fourth lines in units of four lines. Consequently, display data is vertically enlarged by 4/3.

FIG. 8C is a timing chart relevant to the data driver circuit 600 and one-input four-output demultiplexer circuits 603. The data driver circuit 600 uses the signal QVGAHsync (801) as a reference signal, and transfers three display gray-level voltages DataOut (805) (red data R, green data G, and blue data B), which represent one QVGA pixel and of which cycles are equivalent to the 1H period indicated by the QVGA reference signal, from one output port thereof sequentially to one of the one-input four-output demultiplexer circuits 603.

Since the number of one-input four-output demultiplexer circuits 603 is 240, seven hundred and twenty display data items (=240×3 (240×three colors of red, green, and blue)) are transmitted during the 1H period indicated by the QVGA reference signal. The control signals SW1 to SW4 (608-1 to 608-4) have two of them set to an on state during the first third part of the 1H period indicated by the QVGA reference signal, and have one of them set to the on state during the second and third parts of the 1H period. The order in which the control signals are set to the one state depends on the order in which the display gray-level voltages DataOut (805) are transferred. For example, for the R pattern, the display gray-level voltages DataOut (805) are transferred in order of voltages R, G, and B. The associated control signals SWn (where n denotes a value ranging from 1 to 4) are validated in order of signals SW1 and SW4, SW2, and SW3. The gray-level voltages are applied to the respective data lines 607-1 to 607-4 in such a manner that the gray-level voltages will be first applied to two data lines, then applied to one data line, and finally applied to one data line. This means that one color filter is applied to the first sub-pixel and fourth sub-pixel so that identical data will be displayed as the first and fourth sub-pixels.

As mentioned above, QVGA display data of three horizontal pixels by three vertical pixels is displayed as data of four horizontal pixels by four vertical pixels in the display area offering the QVGA×4/3 resolution. Thus, enlarged QVGA display is achieved.

Consequently, the employment of a typical QVGA data driver LSI, and demultiplexers and other simple circuits incorporated in a liquid crystal panel permits multiscanning that is compatible with both the QVGA×4/3 and QVGA graphic standards. The multiscanning modes associated with the QVGA×4/3 and QVGA graphic standards can be dynamically switched. Specifically, the display device checks a manipulation performed at a system or checks transferred display data so as to determine a multiscanning mode.

According to the present embodiment, since enlargement is achieved in units of sub-pixels, there is a fear that a color different from an original one may be produced in some image. However, the employment of a smoothing filter to be applied horizontally can suppress the color difference. Moreover, although the present embodiment supports multiscanning that is compatible with both the QVGA×4/3 and QVGA graphic standards, multiscanning compatible with both QVGA×5/3 and QVGA×N/3 standards can be achieved based on the same idea.

### Third Embodiment

An active matrix type display device and a driving method in accordance with the present invention will be described in conjunction with FIG. 9 to FIGS. 11A and 11B.

FIG. 9 shows the configuration of a liquid crystal display device in accordance with the present invention. The liquid crystal display device includes a data driver circuit 900 and a liquid crystal panel 901. The data driver circuit 900 includes a frame memory 406 and a line latch circuit 401 that latches data representing one line in a display area. The frame memory 406 and line latch circuit 401 are shown in FIG. 4. The line latch circuit 401 holds an input of display data transferred from a system to the data driver circuit 400 (hereinafter an external input) and an input of display data received from the frame memory 406.

The liquid crystal panel 901 includes a display area 902 offering a resolution of 480 horizontal pixels by three colors of red, green, and blue by 320 vertical pixels (which shall be referred to as an HVGA resolution that is a resolution stipulated in the HVGA graphic standard), demultiplexer circuits 903 each having one input port and six output ports, and a gate driver circuit 904 having three hundred and twenty output ports.

When an external input is HVGA display data, external input data representing one line (480 pixels) is saved in the line latch circuit 401 included in the data driver circuit 900. When the external input is QVGA display data, external input data representing one line (240 pixels) and data representing one line (240 pixels) in a QVGA screen image and being stored in the frame memory 406 are saved in the line latch circuit 401 included in the data driver circuit 900.

Each of the demultiplexer circuits 903 is, similarly to the one included in the first embodiment, connected to one output port 905 of the data driver circuit 900, and connected onto six data lines 906-1 to 906-6 included in a display area (a first-pixel red data line Ra, a first-pixel green data line Ga, a first-pixel blue data line Ba, a second-pixel red data line Rb, a second-pixel green data line Gb, and a second-pixel blue data line Bb). In response to six control signals SW1 to SW6 associated with the respective data lines 906-1 to 906-6 (applied to the respective control lines 907-1 to 907-6), the demultiplexer circuit 903 distributes gray-level voltages received via the output port 905 into the data lines 906-1 to 906-6 on a time division basis.

In association with two hundred and forty output ports included in the data driver circuit 900, two hundred and forty one-input six-output demultiplexer circuits 903 are employed. The control signals SW1 to SW6 (applied to the respective control lines 907-1 to 907-6) may be used in common among the two hundred and forty one-input six-output demultiplexer circuits 903.

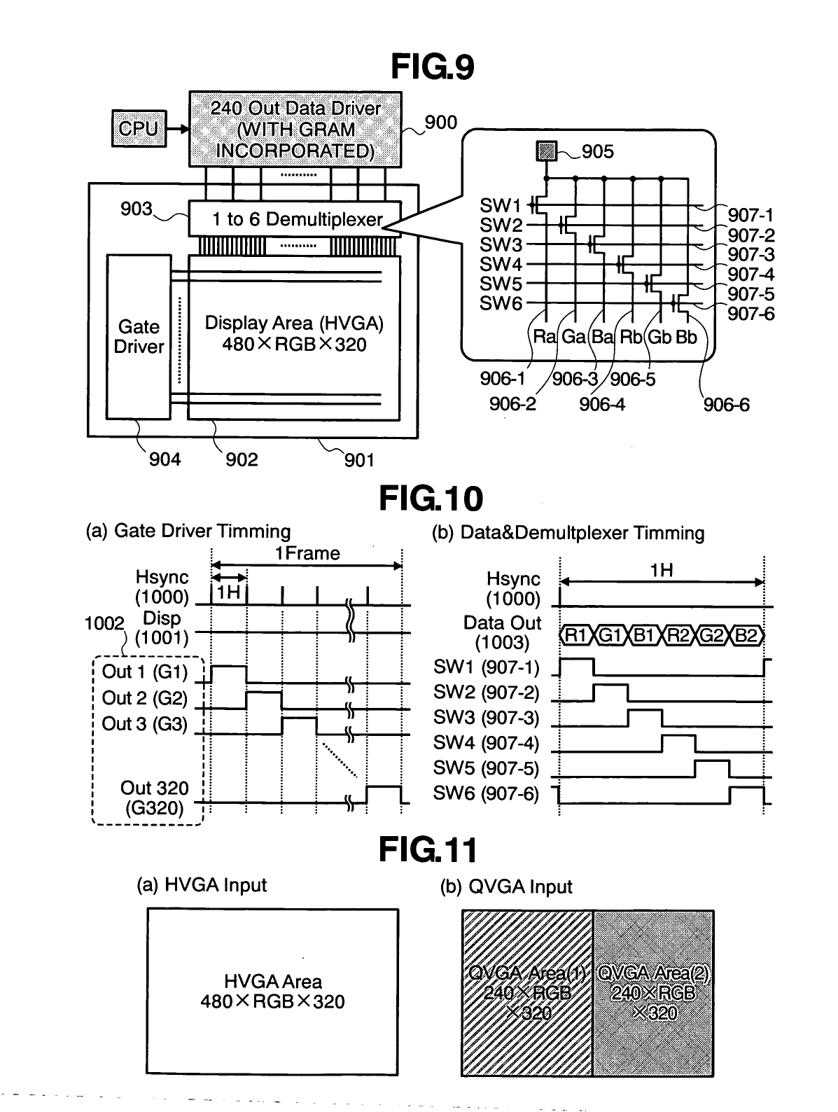

FIGS. 10A and 10B show timing charts concerning a case where HVGA or QVGA display data is received as an input. FIG. 10A is a timing chart relevant to the gate driver circuit 904. Assuming that HVGA data displayed in the display area has a short side thereof extended vertically, QVGA data representing a content provided by a portable cellular phone has a long side thereof extended vertically. In other words, the number of lines contained in one screen image is the same between the HVGA data and QVGA data, and the timing of scanning each line during a horizontal period is therefore the same between them.

Assuming that a horizontal sync signal Hsync (1000) is regarded as a reference signal, a signal that rises at intervals of 1H is adopted as a timing signal with which the output ports of the gate driver circuit 904 are shifted. A mask signal Disp (1001) that signifies unmasking is transferred to the gate driver circuit 904. Consequently, gate outputs 1002 (Out1, Out2, etc., and Out320) are transmitted as signals, with which gates are sequentially opened and which are shifted at intervals of 1H, in the same manner as they are for normal QVGA display.

FIG. 10B is a timing chart relevant to the data driver circuit 900 and demultiplexer circuits 903. The data driver circuit 900 uses the 1H period indicated by the signal Hsync (1000) as a reference, receives display data representing one line in HVGA display (480 pixels) from the line latch circuit, and transfers six display gray-level voltages DataOut 1003 (a first-pixel red gray-level voltage R1, a first-pixel green gray-level voltage G1, a first-pixel blue gray-level voltage B1, a second-pixel red gray-level voltage R2, a second-pixel green gray-level voltage G2, and a second-pixel blue gray-level voltage B2), which represent two pixels and of which cycles are equivalent to one sixth of 1H, from the line latch circuit sequentially to one of the demultiplexer circuit 903.

Since the number of demultiplexer circuits 903 is 240, one thousand, four hundred and forty display data items (=240×6. (480×three colors of red, green, and blue)) are transmitted during the 1H period. The control signals SW1 to SW6 (applied to the respective control lines 907-1 to 907-6) are set to an on state one by one in order dependent on the order in which the display gray-level voltages DataOut (1003) are transferred. At this time, the 1H period is divided into six intervals so that each control signal will assume the on state during one sixth of the 1H period.

For example, when the display gray-level voltages DataOut (1003) are transferred in order of voltages R1, G1, B1, R2, G2, and B2, the associated control signals SWn (where n denotes a value ranging from 1 to 6) are validated in order of signals SW1, SW2, SW3, SW4, SW5, and SW6 so that the gray-level voltages will be applied to the respective data lines 906-1 to 906-6.

As mentioned above, when an HVGA display signal exhibiting as high a resolution as the resolution offered by the display area is received, the received high-resolution HVGA display data can be displayed as shown in FIG. 11A. Moreover, when a QVGA display signal exhibiting a low resolution that is a mainstream resolution exhibited by contents provided by portable cellular phones is received, the QVGA display data can be displayed in a form of two-screen image display. The two-screen image display is such that received QVGA display data is displayed as one screen image, and one screen image data stored in the frame memory 406 is saved in the line latch circuit 401 synchronously with reception of input data and then displayed as the other screen image.

When text such as a mail or Internet contents containing little color information is received (when one pixel is normally represented by eighteen bits, one pixel in text is represented by nine bits), data items representing two screen images are stored in the frame memory. The screen-image data items are saved in the line latch circuit and then displayed synchronously with each other. Thus, two-screen image display is achieved based on the QVGA graphic standard. The multiscanning modes associated with the HVGA and QVGA graphic standards can be dynamically switched. Specifically, the display device checks a manipulation performed at a system or checks input data transferred thereto so as to determine a multiscanning mode.

As described in conjunction with the embodiments, according to the present invention, a high-resolution display device having an existing driver circuit a bit modified and including a multiplexer circuit can support multiscanning using a liquid crystal module, can offer a high resolution, and can display existing contents. In the aforesaid embodiments, an input signal is illustrated to be transferred to the data driver circuit via one interface. Even a configuration that includes numerous interfaces including a CPU interface and red, green, and blue signal interfaces and that resembles a configuration adopted for portable cellular phones may ensure the same actions as the aforesaid ones. The present invention is not limited to the configuration including only one input interface.

What is claimed is:

1. A display device comprising:
a display panel including a plurality of scan lines and a plurality of data lines;
a scan line drive circuit that applies scanning voltages to the scan lines;
a data line drive circuit that transmits data voltages to the data lines;
a data distribution circuit that is interposed between the data line drive circuit and display panel, and that distributes the data voltages, which are transmitted from the data line drive circuit into a plurality of blocks each composed of a plurality of data lines, into data lines constituting each block by dividing one scanning period.

2. The display device according to claim 1, wherein the data line drive circuit includes a multiplexer circuit that transmits data voltages to a plurality of blocks each composed of a plurality of data lines, and the data distribution circuit includes demultiplexer circuits.

3. A display device comprising:
a display panel including a plurality of scan lines and a plurality of data lines;
a scan line drive circuit that line-sequentially applies scanning voltages, with each of which a scan line is selected, to the scan lines during one scanning period;
a data line drive circuit that transmits data voltages, which represent input display data, to the data lines; and
a data distribution circuit that sequentially applies the data voltages, which are transmitted from the data line drive circuit to a plurality of blocks each composed of a plurality of data lines, to data lines constituting each block by dividing one scanning period, wherein:
when the number of effective pixels constituting one screen image and being contained in display data is equal to a resolution offered by the display panel, the data distribution circuit applies a data voltage to one data line during one of time intervals into which the scanning period is divided; and
when the number of effective pixels constituting one screen image and being contained in display data is smaller than the resolution offered by the display panel, the data distribution circuit applies data voltages to one or more data lines during one of the time intervals into which the scanning period is divided.

4. The display device according to claim 3, wherein the data line drive circuit changes the number of time intervals, into which the scanning period is divided, according to whether the number of effective pixels constituting one screen image and being contained in display data is equal to or different from the resolution offered by the display panel, and then applies data voltages.

5. The display device according to claim 3, wherein: when the number of effective pixels constituting one screen image and being contained in display data is equal to the resolution offered by the display panel, the scan line drive circuit applies a scanning voltage to one scan line during one scanning period; and when the number of effective pixels constituting one screen image and being contained in display data is smaller than the resolution offered by the display panel, the scan line drive circuit applies scanning voltages to one or more scan lines during one scanning period.

6. The display device according to claim 3, wherein the resolution is checked in response to a command issued from an external apparatus or checked automatically.

7. A display device comprising:
a display panel including a plurality of scan lines and a plurality of data lines;
a scan line drive circuit that line-sequentially applies scanning voltages, with each of which a scan line is selected, to the scan lines during one scanning period;
a data line drive circuit that transmits data voltages, which represent input display data, to the data lines;
a data distribution circuit that sequentially applies the data voltages, which are transmitted from the data line drive circuit to a plurality of blocks each composed of a plurality of data lines, to data lines constituting each block by dividing one scanning period, wherein:
the data line drive circuit comprises: a memory whose storage capacity is smaller than a resolution offered by the display panel; and a switching circuit that switches a first mode in which one of the data voltages representing input display data is applied to one data line during one of time intervals into which the scanning period is divided, and a second mode in which data voltages representing display data read from the memory are applied to one or more data lines during one of the time intervals into which the scanning period is divided.

8. The display device according to claim 7, wherein the data line drive circuit transmits the same number of data voltages as the number of time intervals, into which one scanning period is divided, according to whether the first mode or second mode is designated.

9. The display device according to claim 7, wherein: in the first mode, the scan line drive circuit applies a scanning voltage to one scan line during one scanning period; and in the second mode, the scan line drive circuit applies scanning voltages to one or more scan lines during one scanning period.

10. The display device according to claim 7, wherein the switching circuit switches the first mode and second mode in response to a command issued from an external apparatus or an output of an internal checking circuit.

11. A display device comprising:
a display panel including a plurality of scan lines and a plurality of data lines;
a scan line drive circuit that line-sequentially transmits scanning voltages, with each of which a scan line is selected, to the scan lines during one scanning period;
a data line drive circuit that transmits data voltages, which represent input display data, to the data lines; and
a data distribution circuit that applies the data voltages, which are transmitted from the data line drive circuit to a plurality of blocks each composed of a plurality of data lines, to data lines constituting each block by dividing one scanning period, wherein:
the data line drive circuit includes a memory whose storage capacity is smaller than a resolution offered by the display panel; and
the data distribution circuit supports a first mode in which one of the data voltages representing input display data is applied to one data line during one of time intervals into which the horizontal period is divided, and a second mode in which data voltages representing display data read from the memory and data voltages representing input display data are applied.

12. The display device according to claim 11, wherein the data line drive circuit transmits part or the whole of input display data to the data lines by adopting display data read from the memory or display data received externally according to whether the first mode or second mode is designated.

13. The display device according to claim 11, wherein the scan line drive circuit transmits a scanning voltage to one scan line during one scanning period in both the first mode and second mode.

14. The display device according to claim 11, wherein the first mode and second mode are switched in response to a command issued from an external apparatus or an output of a checking circuit.

15. A method for driving a display device comprising a display panel that includes a plurality of scan lines and a plurality of data lines, a scan line drive circuit that transmits scanning voltages to the scan lines, a data distribution circuit that applies data voltages to the data lines, and a data line drive circuit that transmits the data voltages, which are applied to a plurality of blocks each composed of a plurality of data lines, to the data distribution circuit, wherein:
the data line drive circuit transmits the data voltages to a plurality of blocks each composed of a plurality of data lines during one scanning period; and
the data distribution circuit applies the data voltages, which are transmitted from the data line drive circuit, to data lines constituting each block by dividing one scanning period.
